(19) United States
(12) Patent Application Publication
(10) Pub. No.: US 2018/0045354 A1
(43) Pub. Date: Feb. 15, 2018

(54) No kink water hose attachment

(71) Applicant: John Kunzelman, Pomona, CA (US)

(72) Inventor: John Kunzelman, Pomona, CA (US)

(21) Appl. No.: 15/231,893

(22) Filed: Aug. 9, 2016

(51) Int. Cl. F16L 55/07; F16K 31/60; F16L 15/00; F16K 5/06

(52) U.S. Cl. CPC F16L 55/07; F16K 5/0626; F16K 31/602; F16L 15/00

(57) ABSTRACT

The current invention is a no kink hose attachment. It consists of a hose attachment with a male and female connections at each end, a valve and a hose extension. The female and male connectors can rotate 360 degrees. It is designed so that a user will never have to kink a water hose to stop the water or take off the attachment.

### CROSS-REFERENCES TO RELATED APPLICATIONS (IF ANY)

None.

### BACKGROUND

### 1. Field of the Invention

The invention relates generally to water hose attachments, and in particular to an attachment that prevents the need for kinks in a hose.

### 2. Description of Prior Art

When using hoses there is always issues with them kinking up and stopping the flow of water. Also there are times when a user wants to stop the flow of water and the only way possible is to kink the hose.

There are a large number of nozzles and hose accessories in current art. But none of the nozzles prevented kinks from developing in the hose.

There is still room for improvement in the art.

### SUMMARY OF THE INVENTION

The current invention is a no kink hose attachment. It consists of a hose attachment with a male and female connections at each end, a valve and a hose extension.

It is designed so that a user will never have to kink a water hose to stop the water or take off the attachment.

The current invention is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 is a top view of the hose attachment;

FIG. 2 is a side view of the hose attachment;

FIG. 3 is a front view of the attachment;

FIG. 4 shows the attachment connecting to other hoses; and

FIG. 5 displays the attachment connected to an end of a hose.

### DESCRIPTION OF THE PREFERRED EMBODIMENT

There are a number of significant design features and improvements incorporated within the invention.

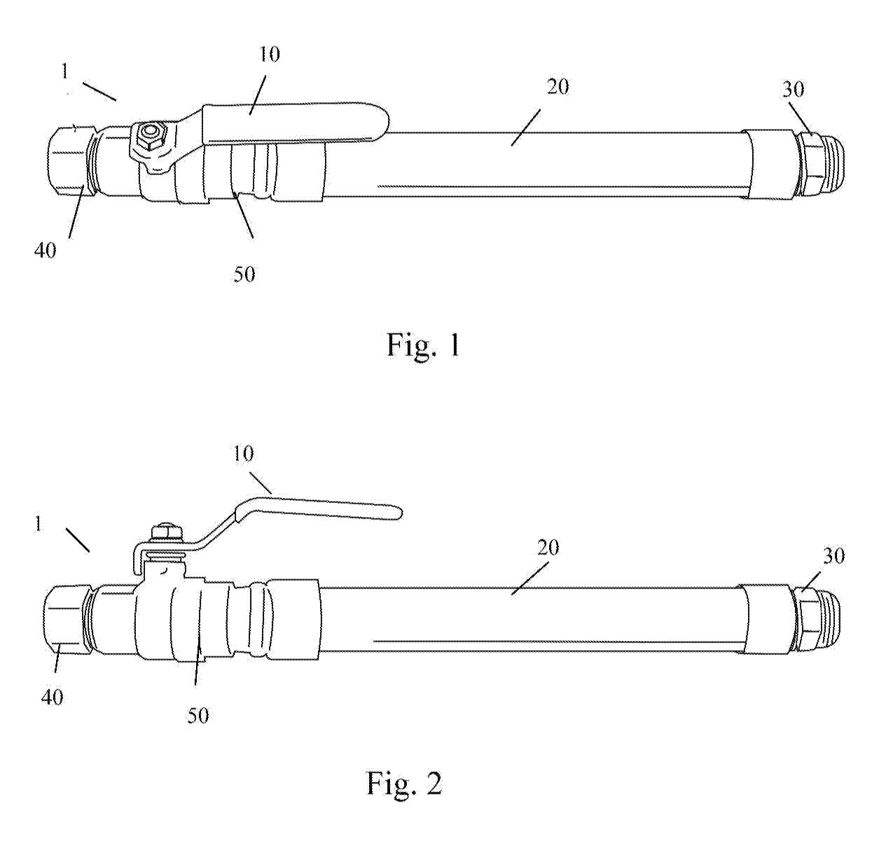

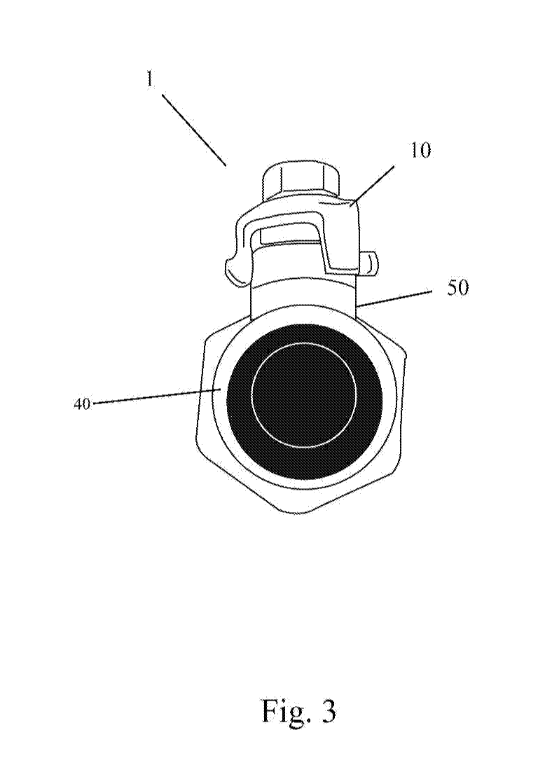

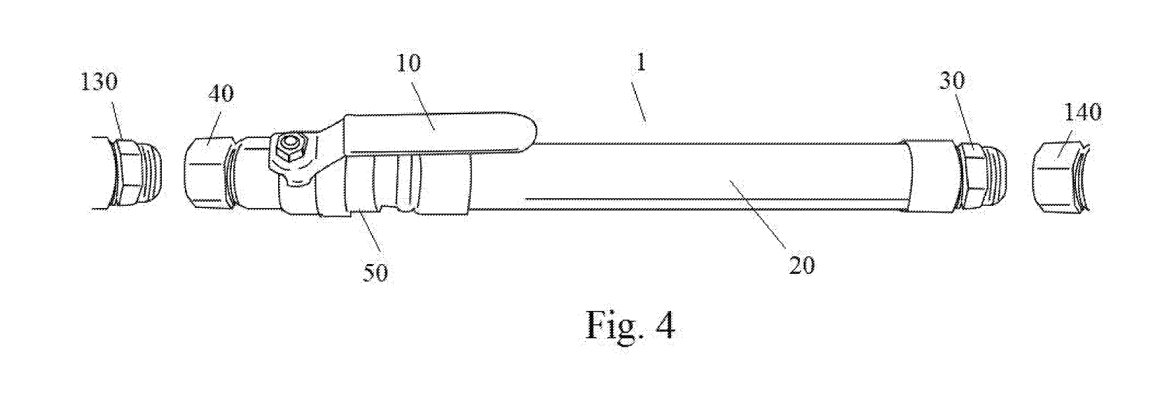

As shown in FIG. 1 through 4, the current invention is directed to a no kink hose attachment 1.

The no kink hose attachment 1 is comprised of a male connector 30 at one end and a female connector 40 at the other end. Between the connectors is a valve 50 and a hose extension 20.

In the shown embodiment the valve 50 is connected to the female end 40 and connected to the hose extension 20. The hose extension 20 is connected to the male end 30. The valve 50 can be attached to either the male 30 or female 40 connectors or can even be placed between them connected to each with a hose extension 20.

In the preferred embodiment, the valve 50 used will be a ball valve with a handle 10. The handle 10 is turned to turn the water flow on and off.

The hose extension 20 will be made of a high quality plastic mesh or plastic hose. It will be a standard diameter hose in the preferred embodiment.

The male 30 and female 40 connectors would swivel 360 degrees while connected allowing the connectors to swivel without moving the valve 50 or the hose extension 20. The will remove the kinking of the hoses that are attached to it. The male connector 30 connects to a female connector 140 of a hose or an attachment such as a sprayer. The female connector 40 connects to a male connector 130 with a hose or a faucet.

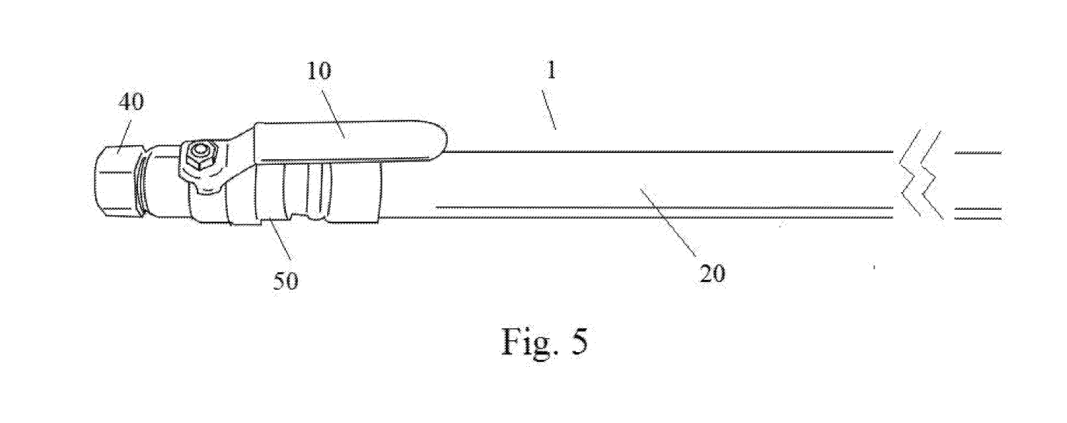

As shown in FIG. 5, the attachment 1 can be built in at the end of a regular hose where it attached directly to the end or middle of the hose without a female attachment. This embodiment can also not have the hose extension.

It is designed so that a user will never have to kink a water hose to stop the water or take off the attachment.

Components, component sizes, and materials listed above are preferable, but artisans will recognize that alternate components and materials could be selected without altering the scope of the invention.

While the methods disclosed herein have been described and shown with reference to particular steps performed in a particular order, it is understood that these steps may be combined, sub-divided, or reordered to form an equivalent method without departing from the teachings of the embodiments. Accordingly, unless specifically indicated herein, the order and grouping of the steps is not a limitation of the embodiments. Furthermore, methods and mechanisms of the embodiments will sometimes be described in singular form for clarity. However, some embodiments may include multiple iterations of a method or multiple instantiations of a mechanism unless noted otherwise. For example, when a connection is disclosed in one embodiment, the scope of the embodiment is intended to also cover the use of multiple connections. Certain features of the embodiments, which may have been, for clarity, described in the context of separate embodiments, may also be provided in various combinations in a single embodiment. Conversely, various features of the embodiments, which may have been, for brevity, described in the context of a single embodiment, may also be provided separately or in any suitable sub-combination. Embodiments described in conjunction with specific examples are presented by way of example, and not limitation. Moreover, it is evident that many alternatives, modifications, and variations will be apparent to those skilled in the art. It is to be understood that other embodiments may be utilized and structural changes may be made without departing from the scope of the embodiments.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device comprising:
a hose attachment with a female connector, a valve, a hose extension and a male connector.

2. A device according to claim 1 comprising:
having the valve be a ball valve.

3. A device according to claim 1 comprising:
where the hose extension is attached to the male connector and the valve.

4. A device according to claim 1 comprising:
where the hose extension is attached to the female connector and the valve.

5. A device according to claim 1 comprising:
where the valve has a handle that is turned to turn the water flow on or off.

6. A device according to claim 1 comprising:
where the female connector is connected to a male connector.

7. A device according to claim 6 comprising:
where the male connector is attached to a hose.

8. A device according to claim 6 comprising:
where the male connector is attached to a faucet.

9. A device according to claim 1 comprising:
where the male connector is connected to a female connector.

10. A device according to claim 6 comprising:
where the female connector is attached to a hose.

11. A device according to claim 6 comprising:
where the female connector is attached to a sprayer.

12. A device according to claim 1 comprising:
where the hose extension is made of a plastic mesh.

13. A device comprising:
a hose attachment with a female connector, a valve connected to an end of a hose.

14. A device according to claim 13 comprising:
having the valve be a ball valve.

15. A device according to claim 13 comprising:
where the valve has a handle that is turned to turn the water flow on or off.

16. A device according to claim 1 comprising:
where the male connector is connected to a female connector.

17. A device according to claim 16 comprising:
where the female connector is attached to a hose.

18. A device according to claim 16 comprising:
where the female connector is attached to a sprayer.
